(19) United States
(12) Patent Application Publication
(10) Pub. No.: US 2024/0052535 A1
(43) Pub. Date: Feb. 15, 2024

(54) HYBRIDIZED RECYCLED FIBERGLASS AND THERMOPLASTIC COMINGLED TECHNICAL YARN

(71) Applicants: University of Tennessee Research Foundation, Knoxville, TN (US); TPI Composites, Inc., Warren, RI (US)

(72) Inventors: Ryan S. Ginder, Knoxville, TN (US); Warren James Smith, Germantown, TN (US); Daniel Paul Rasmussen, Knoxville, TN (US); Stephen C. Nolet, Harpswell, ME (US)

(73) Assignees: University of Tennessee Research Foundation, Knoxville, TN (US); TPI Composites, Inc., Earren, RI (US)

(21) Appl. No.: 18/233,734

(22) Filed: Aug. 14, 2023

Related U.S. Application Data
(60) Provisional application No. 63/397,694, filed on Aug. 12, 2022.

(51) Int. Cl. D02G 3/44; D02G 3/04; D02G 3/18; D02J 13/00; D06B 3/04; D06M 15/55; B29C 70/20; B29C 70/32

(52) U.S. Cl. CPC D02G 3/447; D02G 3/04; D02G 3/18; D02J 13/00; D06B 3/04; D06M 15/55; B29C 70/205; B29C 70/32; D10B 2505/02; D06M 2101/26

(57) ABSTRACT

A method of preparing a continuous yarn from comingled discontinuous glass fiber and thermoplastic fiber is described. An exemplary yarn comprising comingled recycled glass fiber and acrylic fiber is described. Methods of preparing fiber-reinforced composite components from the yarn are also described. The fiber-reinforced composite components can be used in a variety of applications. In an exemplary application, the composite is used to provide component parts for a model rocket body and nosecone.

### RELATED APPLICATIONS

This application claims the benefit of U.S. Provisional Patent Application Ser. No. 63/397,694, filed Aug. 12, 2022; the disclosure of which is incorporated herein by reference in its entirety.

### TECHNICAL FIELD

The subject matter disclosed herein relates generally to methods for preparing fiber-reinforced composites. The fiber-reinforced composite materials can be prepared from a yarn comprising comingled glass and thermoplastic fibers. The glass fiber can comprise recycled glass fiber (RGF) or another discontinuous glass fiber, for example. Thus, the presently disclosed subject matter relates, in some instances, to methods for incorporating RGF into new reinforced polymer composite materials. The presently disclosed subject matter also relates to the yarns comprising the comingled fibers (e.g., yarns comprising comingled RGF and thermoplastic fiber) and to towpregs, textiles, and fabrics comprising the yarns.

### BACKGROUND

Fiber-reinforced composites (e.g., fiber-reinforced polymer (FRP) composites) are widely used in a variety of applications, e.g., automotive components, airplane parts and other aerospace-related components, boat hulls, construction materials for buildings and/or infrastructure (e.g., bridges, roadways, tunnels, sewers, etc.), panels for bathtubs, swimming pools, hot tubs, storage tanks, pipes (e.g., undersea pipe sections) and/or pipe fittings, sporting equipment (e.g., golf clubs, fishing rods, bicycle parts, or baseball bats), personal safety equipment (e.g., helmets and bullet proof vests), and in energy applications (e.g., as blades for wind turbines and as high pressure tubulars for the transport of petroleum). While carbon, aramid, and basalt fibers have also been used in fiber-reinforced composites, glass fiber is a widely used reinforcement due to its combination of good mechanical properties and low cost. Glass fiber is significantly lower cost than carbon fiber, for instance.

The wide-spread production and use of fiber-reinforced composites has resulted in the need for better methods to dispose of composite manufacturing waste (including scrap composite materials) and end-of-life composite parts. Growing regulatory barriers and tipping fees make landfilling these materials less attractive. See Thomason et al., Fibers, 4(2): 18 (2016). Further, recovery and recycling of the constituent composite materials (i.e., reinforcements and/or matrix materials) can divert waste into new value-added products.

Accordingly, there is an ongoing need for methods of preparing fiber-reinforced composites comprising glass fiber, and particularly for preparing composites comprising recycled glass fiber recovered from fiberglass composite waste streams.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In some embodiments, the presently disclosed subject matter provides a method for preparing a fiber-reinforced composite component, the method comprising: (a) forming one or more nonwoven mat comprising comingled glass fiber and thermoplastic fiber; (b) spinning the nonwoven mat into a yarn; and (c) embedding the yarn or a product thereof in a polymeric matrix, thereby preparing a fiber-reinforced composite component. In some embodiments, the glass fiber comprises or consists of recycled glass fiber (RGF).

In some embodiments, the thermoplastic fiber comprises or consists of acrylic fiber. In some embodiments, the thermoplastic fiber is a crimped fiber. In some embodiments, the glass fiber and/or the thermoplastic fiber has a length of about 15 millimeters (mm) to about 125 mm.

In some embodiments, step (a) comprises carding the glass fiber and the polymeric fiber. In some embodiments, the nonwoven mat comprises about 20% by weight to about 80% by weight acrylic fiber. In some embodiments, the nonwoven mat comprises about 50% by weight glass fiber and about 50% by weight acrylic fiber.

In some embodiments, prior to step (c), the yarn is heat-treated. In some embodiments, the thermoplastic fiber comprises acrylic fiber and the yarn is heat-treated prior to step (c) by exposing at least the exterior of the yarn to a temperature of about 230 degrees Celsius (° C.) to about 235° C.

In some embodiments, prior to step (c), the yarn is processed to provide a textile, fabric or other product comprising the yarn.

In some embodiments, step (c) comprises impregnating the yarn or the product thereof with a thermosetting resin and curing the resin. In some embodiments, step (c) comprises: (c1) impregnating the yarn or the product thereof with the thermosetting resin to form an impregnated yarn or product thereof; (c2) forming the impregnated yarn or product thereof into a predetermined shape; and (c3) curing the resin.

In some embodiments, step (c) comprises impregnating the yarn or the product thereof with a thermoplastic resin and polymerizing the resin.

In some embodiments, step (c) comprises impregnating the yarn or the product thereof with a resin selected from the group comprising an epoxy resin, a reactive liquid acrylic resin, an unsaturated polyester resin, a vinyl-ester resin, a polyamide resin and a polybutylene terephthalate resin. In some embodiments, step (c) comprises pulling the yarn through a resin bath, vacuum resin infusion, or film infusion. In some embodiments, step (c) comprises a technique selected from the group comprising filament winding, tube rolling, automated fiber placement (AFP), infusion molding, compression molding, pultrusion, thermoforming, and resin-transfer molding.

In some embodiments, the presently disclosed subject matter provides a fiber-reinforced composite component prepared by a method comprising: (a) forming one or more nonwoven mat comprising comingled glass fiber and thermoplastic fiber; (b) spinning the nonwoven mat into a yarn; and (c) embedding the yarn or a product thereof in a polymeric matrix.

In some embodiments, the presently disclosed subject matter provides a method of preparing a continuous yarn comprising glass and thermoplastic fibers, wherein the method comprises: (a) forming one or more nonwoven mat comprising comingled glass fiber and thermoplastic fiber; and (b) spinning the nonwoven mat into a continuous yarn.

In some embodiments, the presently disclosed subject matter provides a continuous yarn comprising comingled discontinuous glass fiber and thermoplastic fiber. In some embodiments, the discontinuous glass fiber is recycled glass fiber. In some embodiments, the yarn is impregnated with a thermosetting or thermoplastic resin.

In some embodiments, the presently disclosed subject matter provides a fabric or textile comprising the continuous yarn comprising comingled discontinuous glass fiber and thermoplastic fiber. In some embodiments, the presently disclosed subject matter provides an aligned non-crimp fabric comprising the continuous yarn comprising comingled discontinuous glass fiber and thermoplastic fiber.

In some embodiments, the presently disclosed subject matter provides a fiber-reinforced composite comprising: a thermoset or thermoplastic polymeric matrix; and a continuous yarn comprising comingled discontinuous glass fiber and thermoplastic fiber embedded in the polymeric matrix.

Accordingly, it is an object of the presently disclosed subject matter to provide a method of preparing a fiber-reinforced composite comprising a yarn comprising comingled glass and thermoplastic fibers, methods of preparing the yarn comprising the comingled glass and thermoplastic fibers, and to the yarn and composites themselves, as well as related products.

An object of the presently disclosed subject matter having been stated hereinabove, and which is achieved in whole or in part by the presently disclosed subject matter, other objects will become evident as the description proceeds herein below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features and advantages of the present subject matter will be more readily understood from the following detailed description which should be read in conjunction with the accompanying drawings that are given merely by way of explanatory and non-limiting example, and in which:

FIG. 1 is a photographic image showing recycled glass fiber (RGF) and crimped acrylic fiber.

FIG. 2 is a photographic image showing a unidirectional, nonwoven mat comprising comingled recycled glass fiber (RGF) and acrylic fiber (i.e., the two materials shown in FIG. 1).

FIG. 3 is a line drawing showing a drum carder and its use in preparation of a unidirectional fiber mat of comingled fibers.

FIG. 4 is a line drawing showing a spinning wheel and its use in spinning a continuous yarn from the mat shown in FIG. 2.

FIG. 5 is a line drawing showing a bobbin with a comingled yarn prepared by using the spinning wheel shown in FIG. 4.

FIG. 6 is a line drawing showing a continuous yarn of the presently disclosed subject matter being coated with resin by being pulled through a resin bath and the winding of the resin-coated yarn onto a mandrel as part of an exemplary method of forming a fiber-reinforced composite model rocket component.

FIG. 7 is a photographic image showing a cured rocket body part prepared from an epoxy resin-coated continuous yarn of the presently disclosed subject matter undergoing a finishing process using a lathe.

FIG. 8 is a photographic image of a tubular model rocket body comprising a fiber-reinforced composite prepared by a process of the presently disclosed subject matter prior to painting.

FIG. 9 is a photographic image of a model rocket nosecone comprising a fiber-reinforced composite prepared by a process of the presently disclosed subject matter.

FIG. 10 is a photographic image of a model rocket comprising fiber-reinforced composite components (i.e., a structural body and aerodynamic nosecone) prepared by a process of the presently disclosed subject matter.

FIG. 11 is a flow diagram of an exemplary method for preparing a comingled yarn comprising recycled glass fiber and thermoplastic fiber and preparing a fiber-reinforced composite using the yarn.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of time, temperature, weight, concentration, volume, strength, strain, length, width, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, a “monomer” refers to a non-polymeric molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

As used herein the terms “polymer”, “polymeric” and “polymeric matrix” refer to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units. A “copolymer” refers to a polymer derived from more than one species of monomer.

The term “thermoplastic” can refer to a polymer that softens and/or can be molded above a certain temperature, but which is solid below that temperature. Thermoplastic polymers include, but are not limited to, ethylene vinyl acetate copolymers (EVA), polyolefins (e.g., polypropylene (PP)), polyamides, some polyesters (e.g., polybutylene terephthalate (PBT)), styrene block copolymers (SBCs), certain acrylic polymers including but not limited to methylmethacrylates and polymethylmethacrylates, polycarbonates, silicone rubbers, fluoropolymers, thermoplastic elastomers, polypyrrole, polycaprolactone, polyoxymethylene (POM), and mixtures and/or combinations thereof.

The terms “thermoplastic fiber” and “thermoplastic polymeric fiber” refer to a fiber prepared from a thermoplastic polymer.

The term “acrylic” as used herein in reference to fibers refers to fibers prepared from polyacrylonitrile (PAN). PAN refers to a homo- or copolymer comprising repeating constitutional “monomeric” units derived from acrylonitrile (i.e., the compound having the formula CH₂═CH—C═N (which can also be written as CH₂═CHCN) or acrylonitrile and one or more additional vinyl monomers. In some embodiments, acrylic fiber refers to fibers prepared from a PAN wherein at least 85% of the monomeric units are monomeric units derived from acrylonitrile.

In contrast, fibers prepared from PAN copolymers prepared by polymerizing a mixture of monomers comprising at least 35% but less than 85% acrylonitrile can be referred to as “modacrylics.”

The terms “thermoset” and “thermosetting” refer to a polymer that is irreversibly solidified when polymer precursors (e.g., monomers and/or oligomers, which can also be referred to as “resins” or “pre-polymers”) react with one another when exposed to heat, suitable radiation (e.g., visible or ultraviolet light), and/or suitable chemical conditions (e.g., the addition of a chemical polymerization initiator or catalyst (e.g. a peroxide) and/or exposure to suitable pH conditions (such as brought about by the addition of an acid or base)) resulting in a dense network of bonds or cross-links between polymeric molecules. Thermoset polymers include, but are not limited to, epoxies, polyesters, vinyl esters, phenol formaldehyde systems (e.g., Bakelite and other phenolics), polyurethanes, polyurea/polyurethane hybrids, cyanoacrylates, certain acrylic polymers, and mixtures and/or combinations thereof.

The term “resin” when used with regard to a thermosetting polymer can refer to a mixture of the polymer precursors that are further polymerized and/or crosslinked during curing. The term “resin” can also be used herein to refer to monomers, oligomers, and/or mixtures thereof that can be polymerized to form a thermoplastic polymer (i.e., without bonds or cross-links between polymeric molecules).

In some embodiments, the term “curing” as used herein refers to a chemical process of converting a monomer, oligomer, prepolymer or a polymer in a viscous or solid state into a product in which the monomer, oligomer, polymer or prepolymer attains higher molecular mass or becomes a network. Thus, in some embodiments, the terms “cure”, “curing”, and “cured” as used herein can refer to the formation of a solid thermoset polymer from its precursors (e.g. via cross-linking of polymer chains in a thermoset polymer resin). Curing can be done thermally, chemically, or via application of ionizing radiation, such as but not limited to electron beam, x-ray, gamma, photo with photo initiators, and/or ultraviolet (UV)).

As used herein, the term “fiber,” refers to an elongated strand of material in which the length to width ratio is greater than about 10, greater than about 25, greater than about 50 or greater than about 100. Typically, the fibers of the presently disclosed subject matter have a length to width ratio that is greater than 100. A fiber typically has a round, or substantially round, cross section. Other cross-sectional shapes for the fiber include, but are not limited to, oval, square, triangular, rectangular, star-shaped, trilobal, pentalobal, octalobal, and flat (i.e., “ribbon” like) shape. The fiber can have any desired diameter, for example, thicker fibers (or “rods) can be chopped or pelletized, while thinner fibers can be used to prepare yarns or fabrics. In some embodiments, the fiber has a diameter of less than about 250 microns, less than about 200 microns, less than about 150 microns, less than about 100 microns, less than about 75 microns, less than about 50 microns, less than about 25 microns, or less than about 10 microns. In some embodiments, the fiber has a diameter of about 10 microns to about 25 microns. In some embodiments, the fiber has a thickness of about 1 micron to about 250 microns. In some embodiments, the fiber has a thickness greater than about 250 microns. For example, thicker fibers or rods that can be chopped to provide pellets can have a thickness of a few hundred microns (e.g., about 300 microns, about 400 microns, about 500 microns, or about 750 microns) to a few millimeters (mm) (e.g., about 5 mm, about 10 mm, or about 25 mm). In some embodiments, the thicker fibers or rods can have a diameter of about 1 mm to about 5 mm (e.g., 1 mm, 1.5 mm, 2 mm, 2.5 mm, 3 mm, 3.5 mm, 4 mm, 4.5 mm, or about 5 mm). In some embodiments, the thicker fibers or rods can be chopped into pellets having a length of about 1 mm to about 5 mm (e.g., 1 mm, 1.5 mm, 2 mm, 2.5 mm, 3 mm, 3.5 mm, 4 mm, 4.5 mm, or about 5 mm).

The term “yarn” as used herein refers to a twisted bundle of filaments or fibers. The term “technical yarn” as used herein refers to a yarn intended for use in an application other than the production of textiles and fabrics for clothing and home furnishings and/or to yarn having particularly designed functional properties (e.g., strength). For example, technical yarns can be used to prepare insulation or refractory materials or used as a primary reinforcing material when embedded in a thermoset or thermoplastic matrix to prepare a structural composite.

The term “textile” as used herein refers to a product comprising a woven or knit yarn.

The term “fabric” as used herein can refer to a product comprising woven or non-woven fibers, including products prepared by weaving, sewing, stitching, knitting, crocheting, or twisting a yarn.

The term “oriented” as used herein refers to a non-random arrangement of a plurality of fibers. The orientation of the fibers can be unidirectional (i.e., wherein all longitudinal axis of the fibers are all orientated in the same direction), bidirectional (wherein the longitudinal axis of some of the fibers is at a 90° angle to the axis of the other fibers), between a uni- and bidirectional orientation, or combinations thereof (e.g., where there are multiple layers of fibers of differing orientation).

The term “fiberglass” as used herein can refer to a glass fiber-reinforced polymer (GFRP) composite. Thus, “fiberglass” can refer to a composite material comprising a glass fiber embedded in a thermoplastic or thermosetting polymer matrix. In some embodiments, “fiberglass” can also be used to refer to the glass fiber itself, e.g., glass fiber within a GFRP composite, glass fiber suitable for use in preparing a GFRP composite, and/or to glass fiber recovered from a GFRP composite. In some embodiments, glass fiber recovered from a GFRP composite can also be referred to as recycled glass fiber (RGF) or “recycled fiberglass.” Therefore, in some embodiments, RGF and “recycled fiberglass” can be used interchangeably.

The terms “fiber-reinforced composite”, “composite” and “composite material” and the like as used herein refer to a material comprising a continuous polymeric matrix with fibers embedded therein. The polymeric matrix can comprise a thermoset or thermoplastic matrix (i.e., a solid polymeric matrix formed by curing a thermosetting resin or by polymerizing a thermoplastic resin).

### II. Methods of Preparing Comingled Yarns and of Preparing Composites Thereof

In some aspects, the presently disclosed subject matter provides methods for constructing a continuous yarn comprising comingled glass and thermoplastic fibers and to fiber-reinforced composites and other products prepared from the yarn. In some embodiments, the continuous yarn comprises discontinuous glass and thermoplastic fibers. In some embodiments, the yarn comprises recycled glass fiber (RGF), i.e., glass fiber recovered from glass fiber-reinforced polymer composites. Current methods of providing RGF from post-industrial or post-consumer fiberglass sources typically provides discontinuous fibers, which can only be considered for use in applications suitable for staple fibers, but has kept RGF from being used in applications that involve continuous fibers, such as in technical textiles/fabrics, pultrusion, gun roving, sheet molding compound production and the like. Thus, in some embodiments, the presently disclosed subject matter provides an approach to convert these discontinuous fibers back into a continuous form, thereby opening up a wide range of applications that have previously been physically incompatible with recycled fibers.

In some embodiments, the presently disclosed subject matter provides a method for constructing a product component or part comprising the composite. For instance, in an exemplary method described hereinbelow, model rocket parts are prepared from a fiber-reinforced composite of the presently disclosed subject matter. However, the instant composites can also be used in a wide variety of other applications, including those associated with traditional fiberglass, such as, but not limited to, building materials (e.g., roofing); boat, airplane, and automotive parts/components (e.g., fairings, body panels, etc.); wind turbines; tubing (e.g., electrical conduits); tanks (e.g., septic tanks); sporting goods/materials (bicycle parts, surfboards, golf clubs, etc.), safety products (e.g., helmets); insulating materials (e.g., fuse bodies, electrical equipment boxes/containment); etc.

In some embodiments, the presently disclosed subject matter provides a method of preparing a continuous yarn comprising comingled glass and thermoplastic fibers. In some embodiments, the method comprises: (a) forming one or more nonwoven mat comprising comingled glass fiber and thermoplastic fiber; and (b) spinning the nonwoven mat into a yarn.

In some embodiments, the yarn, or a product prepared from the yarn, such as a fabric, textile, or other product prepared from the yarn (e.g., by weaving, knitting, sewing, stitching, chopping, etc.) can be used as the reinforcement for a fiber-reinforced composite or a component comprising the fiber-reinforced composite. In some embodiments, the method of preparing a fiber-reinforced composite component comprises: (a) forming one or more nonwoven mat comprising comingled glass fiber and thermoplastic fiber; (b) spinning the nonwoven mat into a yarn; and (c) embedding the yarn or a product thereof in a polymeric matrix, thereby providing the composite component.

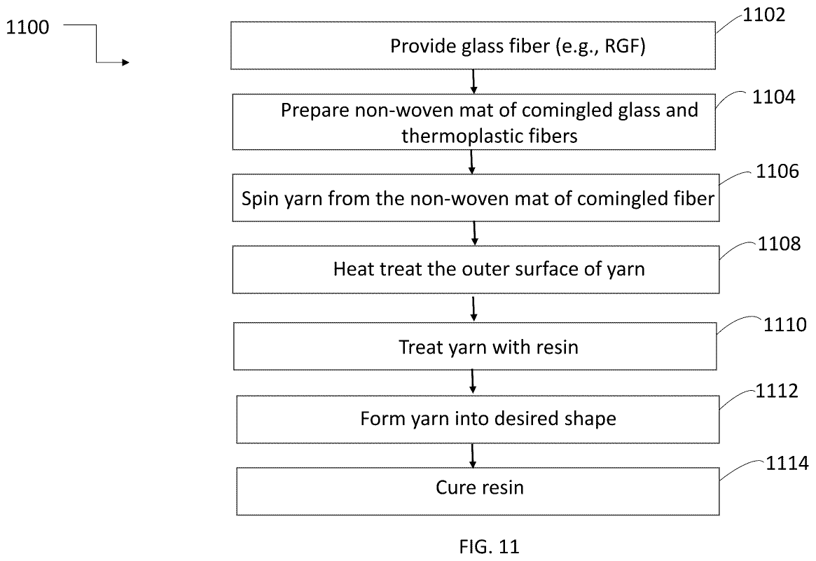

FIG. 11 shows exemplary method 1100 for preparing a continuous yarn comprising comingled glass and thermoplastic fibers and of preparing a fiber-reinforced composite material comprising the yarn according to some embodiments of the presently disclosed subject matter. Method 1100 includes step 1102, wherein glass fiber is provided. The glass fiber can be any suitable type of glass fiber, e.g., E-glass (i.e., alumino-borosilicate glass with less than 1% w/w alkali oxide), A-glass, E-CR-glass, H-glass, R-glass, S-glass, D-glass, C-glass, quartz glass, or any combination thereof. In some embodiments, the glass fiber is E-glass fiber. In some embodiments, the glass fiber has a diameter of about 9 micrometers (μm or microns) to about 25 microns or about 10 μm to about 25 μm (e.g., 10, 11, 12, 13, 14, 15, 16, 17, 18, 19, 20, 21, 22, 23, 24, or 25 μm). In some embodiments, the glass fiber has a diameter of about 9 μm to about 17 μm. The length of the glass fibers can vary. In some embodiments, the length of the glass fiber is about 15 millimeters (mm) to about 125 mm (e.g., 15, 20, 25, 30, 35, 40, 45, 50, 55, 60, 65, 70, 75, 80, 85, 90, 95, 100, 105, 110, 115, 120, or 125 mm). In some embodiments, the length of the glass fiber is about 3 millimeters (mm) to about 26 millimeters (mm). In some embodiments, the length of the glass fiber is shorter (e.g., between about 0.2 to about 0.3 mm).

In some embodiments, the glass fiber (e.g., the discontinuous glass fiber) is virgin glass fiber i.e., glass fiber not previously used as a reinforcement material in a composite. In some embodiments, some or all of the glass fiber (e.g., the discontinuous glass fiber) is glass fiber that has been recovered from fiberglass (e.g., fiberglass scraps or an end-of-life fiberglass object, e.g., end-of-life fiberglass aircraft, boat or automobile parts; end-of-life fiberglass wind turbine blades; end-or-life fiberglass construction materials; end-of-life fiberglass sporting equipment (e.g. surfboards, etc.); end-of-life fiberglass protective gear (e.g. helmets); end-of-life fiberglass piping or tanks; or other end-of-life fiberglass products (e.g., orthopedic casts, bath and/or shower enclosures, hot tubs, etc.). Thus, in some embodiments, the glass fiber comprises or consists of recycled glass fiber (RGF) provided by/recovered from recycling fiberglass.

Regardless of the source or type of glass fiber, in some embodiments, the glass fiber can be treated with a sizing and/or finishing agent. For example, the sizing and/or finishing agents can include a coupling agent, a film forming agent, and/or an additive. Coupling agents include, for example, aminosilane-based agents, epoxysilane-based agents, vinylsilane-based agents, methacrylosilane-based agents, ureidosilane-based agents, boran-based agents, titanate-based agents, aluminum-based agents, chromium-based agents, and zirconium-based agents; as well as colloidal gels such as colloidal silica and colloidal alumina. In some embodiments, the coupling agent is an alkoxysilane. In some embodiments, the alkoxysilane is an aminoalkyltrialkoxysilane, such as a compound selected from the group including, but not limited to, γ-aminopropyltriethoxysilane, γ-aminopropyltrimethoxysilane, γ-(2-aminoethyl)amiopropyltriethoxysilane, and the like.

Suitable film forming agents include resins similar to the type of resin into which the recycled glass fiber is intended to be embedded to make a new GFRP composite material. Thus, film forming agents include, but are not limited to, epoxy and polyester resins, polyurethane resins, acrylic resins, polyvinylalcohol, diisocyante-blocked ethylene oxide or propylene oxide copolymers, polyvinylpyrrolidone, dicyanformaldehyde resin, gelatin, etc.

Additives include, but are not limited to, lubricants, antioxidants, antistatic agents, friction reducers, and pH adjusters. Examples of friction reducers include, but are not limited to, hydrogenated cured animal or vegetable oils, paraffin wax, and ester-type synthetic oils. Examples of lubricants include, but are not limited to, butyl stearate, tetraethylenepentamine distearate, hydrogenated castor oil, imidazoline-based fatty acid amides, cationic fatty acid amides, cationic polyethyleneimine polyamide, and bisphenol A poly(oxyethylene) ether glycol. Examples of antistatic agents include various surfactants such as anionic surfactants, cation surfactants, and nonionic surfactants. Examples of pH adjusters include, but are not limited to, ammonia and acetic acid.

When the glass fiber comprises or consists of RGF, the RGF can be provided by any suitable method. Recycling processes for GFRP composite materials currently in use typically involve collecting materials for recycling, a mechanical size reduction step (e.g., cutting or shredding the collected materials to smaller sizes that can be more easily fed into a pyrolysis reactor), and a pyrolysis step, which removes the polymeric resin and provides hydrocarbon gases (e.g., methane, ethane, ethylene, propane, propylene, etc.) and liquids with high energy content. In some embodiments, the RGFs are provided by molten salt-assisted pyrolysis of fiberglass material as described in U.S. Patent Application Publication No. 2020/0140315, which is incorporated herein by reference in its entirety. Briefly, molten salt-assisted pyrolysis of fiberglass material can include collecting pyrolyzed GFRP composite material, including any char-coated pyrolyzed glass fibers, and immersing it in a molten salt bath comprising molten KNO₃ to remove any char and other inorganic impurities from the surface of the glass fiber remaining from the composite, and then rinsing the fibers. Due to ion exchange reactions in the surface layer of the recovered glass fibers that can take place using the molten salt bath, defects in the surface of the glass can be healed and/or the strength of the glass fiber can be increased.

Continuing with FIG. 11, in step 1104, a non-woven mat of glass fiber provided in step 1102 and thermoplastic fiber can be prepared. The thermoplastic fiber can comprise fiber of any suitable thermoplastic polymer or mixture of thermoplastic polymers or can comprise a mixture of thermoplastic fibers comprising different thermoplastic polymers. The selection of thermoplastic polymer(s) can be based on the end use of the yarn spun from the mat or the composite prepared from the yarn. In some embodiments, the thermoplastic polymer fiber comprises a polyamide fiber (e.g., a nylon fiber, such as a fiber prepared from nylon-6). In some embodiments, the selection of thermoplastic polymer fiber can be based on maximizing matrix compatibility in a composite (e.g., using nylon-6 fiber with the intention of using yarn spun from the mat in the thermoforming of a nylon-6 composite part) or in improving matrix compatibility while also protecting the fiber's aspect ratio from melting (e.g., spinning with nylon-6,6 when making a yarn for reinforcing a part with a lower melting/molding temperature nylon, such as nylon-6). In some embodiments, the thermoplastic fiber comprises or consists of acrylic fiber. Acrylic fiber is widely used in the textile industry, e.g., for preparing clothing and/or home furnishings. In addition, the use of acrylic fiber can improve compatibility with resins such as those comprising methylmethacrylate monomers when preparing composites comprising a thermoplastic acrylic matrix.

In some embodiments, the thermoplastic fiber (e.g., the acrylic fiber) comprises or consists of crimped (i.e., “wavy”) fiber. The inclusion/use of crimped thermoplastic fiber can increase friction between the thermoplastic fiber and the glass fiber, thereby improving the tensile properties of the yarns comprising the fibers, and/or improve mechanical interlocking of the fibers during spinning to produce a yarn more resistant to unwinding.

In some embodiments, the nonwoven mat comprises about 20% by weight to about 80% by weight (e.g., 20%, 25%, 30%, 35%, 40%, 45%, 50%, 55%, 60%, 65%, 70%, 75%, or 80% by weight) of the thermoplastic fiber. In some embodiments, the ratio of glass fiber (e.g., RGF) to thermoplastic fiber in the non-woven mat is about 1:4 to about 4:1 (e.g., 1:4, 1:3, 1:2, 1:1, 2:1, 3:1, or 4:1). In some embodiments, the ratio of glass fiber (e.g., RGF) to thermoplastic fiber in the non-woven mat is about 1:1. In some embodiments, the glass fiber and the thermoplastic fiber can have about the same length (e.g., overlapping length ranges). Thus, in some embodiments, the glass fiber and the thermoplastic fiber both have a length of about 15 mm to about 125 mm.

In some embodiments, the non-woven mat can be prepared by carding and/or combing the fibers, e.g., to comingle and/or orient the fibers. In some embodiments, the non-woven mat is prepared so that the majority of fibers in the mat (e.g., more than 50%, more than 60%, more than 70%, more than 80%, etc.) of the fibers are aligned. Thus, carding and/or combing can provide suitable blending, entanglement, and/or alignment of the glass and thermoplastic fibers. Carding, for example, can be performed by hand or mechanized. Devices and machines for carding fibers (i.e., “carders”) are known in the art (e.g., for textile production). For example, suitable carders are commercially available from Brother Drumcarder (Silverton, Oregon, United States of America).

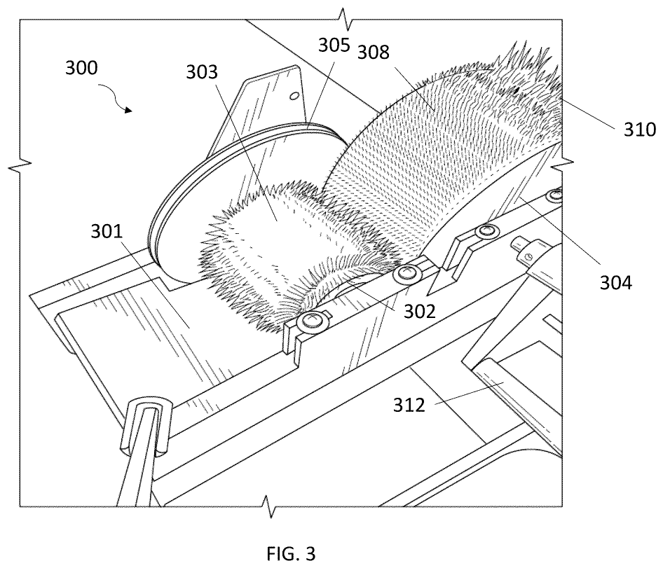

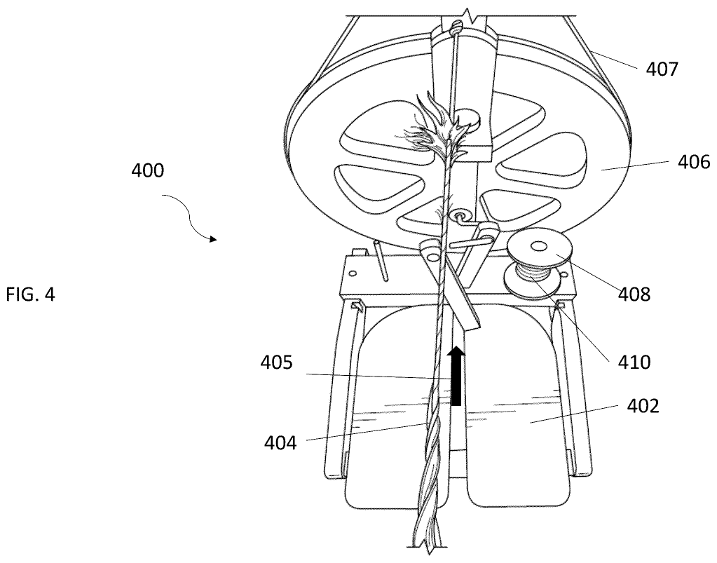

An exemplary process of carding fibers is shown in FIG. 3. FIG. 3 shows drum carder 300. Drum carder 300 includes smaller “licker-in” drum 302 and larger “storage” drum 304. Smaller drum 302 picks up fibers 303 from feed tray 301. Fibers 303 are then picked up by larger drum 304 when the drums are turned via belt/chain drive 305 and using hand crank 312. Both smaller drum 302 and larger drum 304 are covered by card clothing, a fabric or other backing material covered with wire pins that act to straighten fibers being carded. Portion 308 of the card clothing of larger drum 304 is visible, while another portion is obscured by straightened/carded fibers 310 that have collected on larger drum 304. Straightened/carded fibers 310 can be removed from larger drum 304 after it fills with carded fibers, thereby providing the non-woven mat.

Continuing with FIG. 11, in step 1106, the nonwoven mat is spun into a yarn. The spinning can be performed via any suitable spinning apparatus. The spinning can be performed by hand or using a mechanized apparatus. The spinning can be quantified by the number of “turns” per unit length. In some embodiments, the spinning is performed for about 0.25 turns to about 10 turns per centimeter. In some embodiments, the spinning is performed for about 2 turns per centimeter.

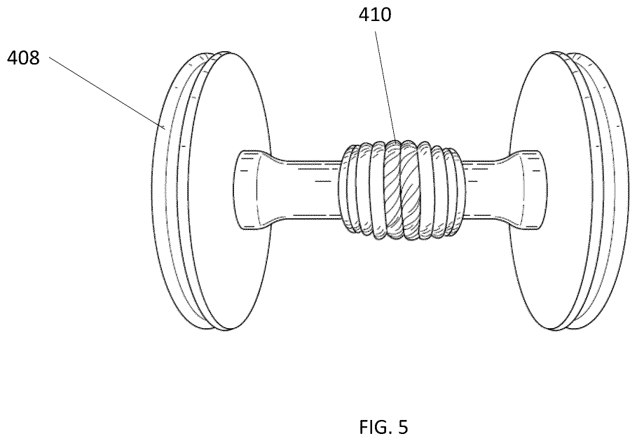

FIG. 4 shows an exemplary yarn spinning process using a traditional spinning machine 400. Traditional spinning machine 400 includes foot wheel/treadle 402, which can be used to spin drive/fly wheel 406, which spins a flyer (not shown in FIG. 4) via drive band 407. Non-woven mat 404 is fed to the flyer in direction 405, is twisted in the flyer into a continuous yarn, and fed onto a bobbin. Filled bobbin 408 with continuous yarn 410 has been removed from the flyer and placed at the bottom of wheel 406. Another view of bobbin 408 and continuous yarn 410 is shown in FIG. 5. The spun continuous yarn (i.e., the produced technical yarn) comprises comingled glass fiber (e.g., RGF) and thermoplastic fiber (e.g., acrylic fiber).

If desired, the continuous yarn can be coated (or “impregnated”) with resin and used to provide a fiber-reinforced composite. Alternatively, the yarn can be used as a technical yarn for preparing products, such as fabrics or textiles. Thus, in some embodiments, the yarn can be further processed (e.g., by weaving, braiding, knitting, stitching, sewing, crocheting, or the like) to provide a product. For example, the yarn can be used to prepare aligned non-crimp fabrics, including, but not limited to multi-axial non-crimp fabrics. The yarn can be impregnated with a resin to form a towpreg or one of the fabrics comprising the yarn can be impregnated with resin and provided in the form of a prepreg.

Continuing again with FIG. 11, in optional step 1108, in some embodiments, the continuous yarn is heat treated. In some embodiments, the heat treatment can melt or partially melt the thermoplastic fiber in the yarn. Heat treating can result in shrinkage of the yarn, which can, in some embodiments, provide greater compatibility between the yarn and a resin or polymeric matrix when the yarn is used in a composite. Due to the smooth surface of glass, glass fiber does not comprise a degree of frictional interlocking typically associated with the provision of a consistent yarn. The heat treatment can facilitate plastic flow of the polymer around the glass, increasing the friction/mechanical interlocking between the fibers.

In some embodiments, heat treatment can comprise directing a heated stream of air at a surface of the yarn (e.g., using a hair dryer or similar device) or passing the yarn through an oven. In some embodiments, the heat treating is performed at a temperature suitable to melt or partially melt the thermoplastic fiber of the yarn. Thus, the temperature used for the heat treating can depend on the melting temperature of the thermoplastic fiber. In some embodiments (e.g., when the thermoplastic fiber comprises acrylic fiber), the heat treatment comprises heating at least the exterior surface of the yarn to a temperature of about 230 degrees Celsius (° C.) to about 235° C. (e.g., about 230° C., about 231° C., about 232° C., about 233° C., about 234° C., or about 235° C.

Once the yarn or product thereof is prepared, and, if desired, heat treated, it can be embedded in a polymeric matrix. Thus, the yarn or product thereof can be contacted with a resin corresponding to the polymeric matrix of the composite desired. The resin can be thermosetting or thermoplastic. In some embodiments, the resin is a thermosetting resin. Thus, in some embodiments, embedding the yarn or product thereof comprises impregnating the yarn or product with a thermosetting resin and curing the resin. For example, in FIG. 11, following step 1108 (or step 1106, if heat treating is not performed), the yarn is treated with resin in step 1110. In some embodiments, embedding comprises: (c1) impregnating the yarn with the thermosetting resin to form an impregnated yarn; (c2) forming the impregnated yarn into a predetermined shape (e.g., via filament winding, i.e., winding the yarn around a solid form, such as a mandrel); and (c3) curing the resin to provide the fiber-reinforced composite component. Suitable thermosetting polymer resins include, but are not limited to, polyester, epoxy, phenolic, vinyl ester, cyanate ester, polyurethane, silicone, polyamide, and polyamide-imide resins. In some embodiments, the resin is an epoxy, polyester, or vinyl ester resin.

Alternatively, in some embodiments, the resin is a thermoplastic resin. Thus, in some embodiments, the embedding of the yarn or product thereof comprises impregnating the yarn or product thereof with a thermoplastic resin and polymerizing the resin. For example, in some embodiments, the resin is a liquid resin comprising methmethacrylate (MMA) and/or polymethyl methacrylate monomers that, when coated on the yarn and polymerized, form a fiber-reinforced acrylic thermoplastic. Composites comprising thermoplastic matrices can be thermoformed or compression molded to form and, if desired, reform a variety of products. Accordingly, in some embodiments, the resin is selected from an epoxy resin, a reactive liquid acrylic resin, an unsaturated polyester resin, a vinyl-ester resin, a polyamide resin (e.g., nylon-6, nylon-6,6, or nylon-6,12) and a polybutylene terephthalate (PBT) resin.

In some embodiments, the resin is an epoxy resin. Epoxy resins for use according to the presently disclosed subject matter include low molecular weight pre-polymers or higher molecular weight oligomers and polymers. Typically, the epoxy resin comprises at least two epoxide groups per molecule, and can be a polyfunctional epoxide having three, four, or more epoxide groups per molecule. In some embodiments, the epoxy resin is liquid at ambient temperature. Suitable epoxy resins include the mono- or poly-glycidyl derivative of one or more of the group of compounds comprising aromatic diamines, aromatic monoprimary amines, aminophenols, polyhydric phenols, polyhydric alcohols, polycarboxylic acids and the like, or a mixture thereof. In some embodiments, the epoxy resin is selected from the group comprising: (i) glycidyl ethers of bisphenol A, bisphenol F, dihydroxydiphenyl sulphone, dihydroxybenzophenone, and dihydroxy diphenyl; (ii) epoxy resins based on Novolacs; and (iii) glycidyl functional reaction products of m- or p-aminophenol, m- or p-phenylene diamine, 2,4-, 2,6- or 3,4-toluoylene diamine, 3,3′- or 4,4′-diaminodiphenyl methane. In some embodiments, the epoxy resin is selected from the diglycidyl ether of bisphenol A (DGEBA); the diglycidyl ether of bisphenol F (DGEBF); O,N,N triglycidyl-para-aminophenol (TGPAP); O,N,N-triglycidyl-meta-aminophenol (TGMAP); and N,N,N′,N′-tetraglycidyldiaminodiphenyl methane (TGDDM).

In some embodiments, the epoxy resin further comprises a curing agent(s) and/or catalyst(s). The use of a curing agent and/or catalyst can increase the cure rate and/or reduce the cure temperature of the resin. Curing agents suitable for use with epoxy resins, include, but are not limited to, amines (e.g., polyamines and aromatic polyamines), imidazoles, acids, acid anhydrides, phenols, alcohols, and thiols (e.g., polymercaptans). In some embodiments, the curing agent is a polyamine compound selected from the group comprising diethylenetriamine (DETA), triethylenetetramine (TETA), tetraethylenepentamine (TEPA), ethyleneamine, aminoethylpiperazine (AEP), dicyanamide (Dicy), diethyltoluenediamine (DETDA), dipropenediamine (DPDA), diethyleneaminopropylamine (DEAPA), hexamethylenediamine, N aminoethylpiperazine (N-AEP), menthane diamine (MDA), isophoronediamine (IPDA), m-xylenediamine (m-XDA) and metaphenylene diamine (MPDA). In some embodiments, the amine curing agent is selected from the group including 3,3′ and 4-,4′-diaminodiphenylsulphone (DDS); methylenedianiline; bis(4-amino-3,5-dimethylphenyl)-1,4-diisopropylbenzene; bis(4-aminophenyl)-1,4-diiso-propyl-benzene; 4,4′methylenebis-(2,6-diethyl)-aniline (MDEA); 4,4′ methylene-bis-(3-chloro, 2,6-diethyl)-aniline (MCDEA); 4,4′methylenebis-(2,6-diisopropyl)-aniline (M-DIPA); 4,4′methylenebis-(2-isopropyl-6-methyl)-aniline (M-MIPA); 4 chlorophenyl-N,N-dimethyl-urea; 3,4-dichlorophenyl-N,N-dimethyl-urea, and dicyanodiamide. Bisphenol chain extenders, such as bisphenol-S or thiodiphenol, can also be useful as curing agents for epoxy resins. Suitable curing agents further include anhydrides, particularly polycarboxylic anhydrides, such as nadic anhydride, methylnadic anhydride, phthalic anhydride, tetrahydrophthalic anhydride, hexahydrophthalic anhydride, methyltetrahydrophthalic anhydride, endomethylenetetrahydrophtalic anhydride, or trimellitic anhydride.

Suitable catalysts are well known in the art and include Lewis acids or bases. Examples include compositions comprising boron trifluoride, such as the etherates or amine adducts thereof (for instance the adduct of boron trifluoride and ethylamine).

Contacting a yarn or product thereof with a resin can be performed by any suitable technique known in the art. For example, the yarn or product thereof can be coated/impregnated with the resin via dipping, spraying, or painting. In some embodiments, the coating/impregnating is performed by pulling the yarn or product thereof through a resin bath, via vacuum resin infusion, or via film infusion. In some embodiments, the yarn is pulled through a resin bath or dipped in a resin bath. The coated yarn can also be referred to as a “saturated yarn” or an “impregnated yarn.”

When the resin is a thermosetting resin, in some embodiments, the yarn can be contacted with the resin and shaped in separate steps. For instance, as shown in FIG. 11, in step 1112, the treated (e.g., coated) yarn from step 1110 can be formed into a desired shape (i.e., an “uncured component”). Thus, in some embodiments, the use of the yarn according to the presently disclosed subject matter can be particularly advantageous in preparing composites with curved or irregular shapes. In some embodiments, step 1112 comprises placing the coated yarn over a form (e.g., a solid form) or scaffold having the desired shape of the future composite. In some embodiments, the coated yarn is wound around a form. In some embodiments, the form is a mandrel or other tube-shaped form. Thus, in some embodiments, the forming is performed by wrapping the coated yarn from step 1110 around a mandrel. Alternatively, step 1112 can comprise placing the yarn in a mold. When using a mold, the yarn can be contacted with resin prior to or after it is placed in a mold. Thus, in some embodiments, treating (e.g. impregnation or coating) step 1110 and shaping step 1112 are combined (e.g., can take place using one apparatus and/or can take place at about the same time).

In some embodiments, the yarn (e.g. the coated yarn) can be shaped by forming the yarn (e.g., the coated yarn) into a desired shape where the exterior surface of one portion of the yarn (e.g., the coated yarn) is in physical contact with the exterior surface of at least a second portion of the yarn (e.g., the coated yarn), e.g., so that when resin (i.e., the thermosetting resin) is cured (e.g., in step 1114 of FIG. 11), the first portion of the coated yarn and the second portion of the coated yarn are joined to one another via a cured polymeric matrix.

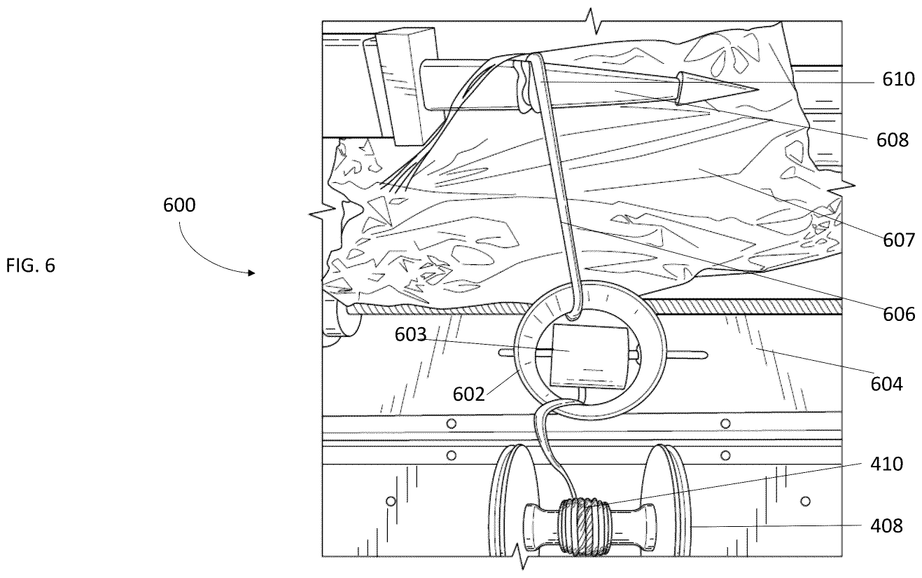

FIG. 6 shows exemplary coating and shaping steps that are performed sequentially in an embodiment comprising a thermosetting resin. For instance, in FIG. 6, composite-forming apparatus 600 is provided where continuous yarn 410 from FIGS. 4 and 5 is pulled from bobbin/reel 408 into open tube 602 and under roller 603 so that yarn 410 is submerged in resin bath 604 (i.e., comprising a thermosetting resin, such as an epoxy resin). Resin-coated yarn 606 is then wound around mandrel 608 to form coil 610 of resin-coated yarn. Foil sheet 607 is positioned under the mandrel to catch any resin that drips from resin-coated yarn 606 and coil 610.

Following step 1112, the resin (i.e., the thermosetting resin) is cured. In some embodiments, the curing of step 1114 of FIG. 11 comprises exposing the formed coated yarn/uncured component to heat and/or light. In some embodiments, the curing comprises exposing the formed coated yarn to ambient conditions (e.g., room temperature conditions) for a period of time (e.g., a few minutes, hours, or days). In some embodiments (e.g., when the coated yarn is wound around a mandrel or other tube-shaped form), the formed coated yarn is rotated during curing. After curing, the resulting FRP composite can be finished as desired, e.g., by additional shaping (e.g., trimming the cured composite or etching the surface of the cured composite), coating, or painting of the surface of the FRP with a coating, e.g., paint.

While FIG. 6 outlines a method comprising impregnating a yarn by pulling it through a thermosetting resin bath and winding the coated yarn around a mandrel (i.e., where the winding can also be referred to by the term “filament winding”), other techniques known in the art of preparing fiber-reinforced composites can be used for embedding the yarn or product thereof in a polymeric matrix, including methods where the continuous yarn is chopped to provide a staple fiber and the staple fiber is embedded in a polymeric matrix. These methods include, but are not limited to, tube rolling, automated fiber placement (AFP), infusion molding, compression molding, pultrusion, thermoforming, resin-transfer molding (RTM), vacuum-assisted resin-transfer molding (VARTM) high pressure compression resin-transfer molding (HP-CRTM), resin film infusion (RFI), reaction injection molding (RIM), and the like. In some embodiments, embedding the yarn or a product thereof comprises performing a technique selected from the group including, but not limited to, filament winding (e.g., wet or dry filament winding), tube rolling, automated fiber placement (AFP), infusion molding, compression molding, pultrusion, thermoforming, and resin-transfer molding.

In some embodiments, the presently disclosed subject matter provides a fiber-reinforced composite material. In some embodiments, the presently disclosed subject matter provides a fiber-reinforced composite material prepared according to a method of the presently disclosed subject matter and/or comprising a yarn (e.g., a continuous yarn) comprising comingled glass and thermoplastic fibers, wherein the yarn is embedded in a polymeric matrix, e.g., a solid polymeric matrix formed from by curing a thermosetting polymer resin or polymerizing thermoplastic polymer resin. In some embodiments, the glass fiber is RGF.

In some embodiments, the presently disclosed subject matter comprises a yarn comprising comingled glass and thermoplastic fibers. In some embodiments, the glass fiber is RGF. In some embodiments, the yarn is a continuous yarn comprising comingled discontinuous glass fiber and thermoplastic fiber. In some embodiments, the glass fiber is RGF.

In some embodiments, the yarn is impregnated or coated with a thermosetting or thermoplastic resin. Thus, for example, in some embodiments, the presently disclosed subject matter provides a towpreg comprising a continuous yarn comprising discontinuous glass fiber (RGF).

In some embodiments, the presently disclosed subject matter provides a fabric, textile or other product comprising the yarn (e.g., the continuous yarn). In some embodiments, the fabric comprises an aligned non-crimp fabric (e.g., a multi-axial, non-crimp fabric).

In some embodiments, the presently disclosed subject matter provides a fiber-reinforced composite comprising a continuous yarn comprising comingled glass and thermoplastic fibers embedded in a polymeric matrix (e.g., a solid thermoset or thermoplastic polymeric matrix).

According to a non-limiting example described hereinbelow, fiber-reinforced polymer composite components for a model rocket were prepared according to the presently disclosed subject matter by constructing a mat comprising fiberglass (e.g., recycled fiberglass) and thermoplastic fibers (e.g., acrylic fibers). The mat can be prepared by feeding glass and thermoplastic fibers into a carding machine to form a mat (e.g., a unidirectional mat) comprising the two fibers (i.e., the fiberglass and the thermoplastic fibers). The comingled fibers can be spun into a yarn. In some embodiments, the exterior of the yarn is heat treated. The yarn can be coated with a thermoplastic or thermoset polymeric resin (e.g., an epoxy resin). For example, the yarns can be pulled through a bath comprising the resin. Then the coated yarn can be shaped into a rocket body part (e.g., by winding the yarn on a mandrel). In some embodiments, the body part is cured while rotating the part (e.g., by maintaining the rotation of the mandrel on which the yarn is wound). After curing, the rocket body part can be trimmed and polished. In some embodiments, the rocket part is a rocket body. In some embodiments, the rocket part is a rocket nosecone.

In some embodiments, a rocket can be assembled using a rocket body and/or nosecone prepared according to the presently disclosed subject matter. Rocket fins (which can also be prepared from mats comprising the comingled fiberglass and polymer fibers) can be attached to the rocket body via a suitable adhesive. Parachutes, motors, or other internal rocket parts can be added, also using adhesive, if desired. The rocket can optionally be painted or otherwise finished as desired.

### Example

Recycled glass fibers yarns were produced by comingling recycled fiberglass with crimped acrylic fiber of the same length in a carding process. Recycled glass fibers can be prepared, for example, as described in U.S. Patent Application Publication No. 2020/0140315, the disclosure of which is incorporated by reference herein in its entirety. The carding process yields a unidirectional mat that was then spun into yarn.

To produce the rocket, this yarn was pulled through an epoxy bath then wound around mandrels to form a rocket body and nosecone. Once cured the parts were trimmed on a lathe and then painted. To make the fins nonwoven mats were coated in epoxy, allowed to harden, trimmed to shape, then painted to match the rest of the rocket. Once all pieces were prepped the rocket was assembled and the motor and other interior pieces were put into the rocket using adhesives where necessary.

### Yarn Production:

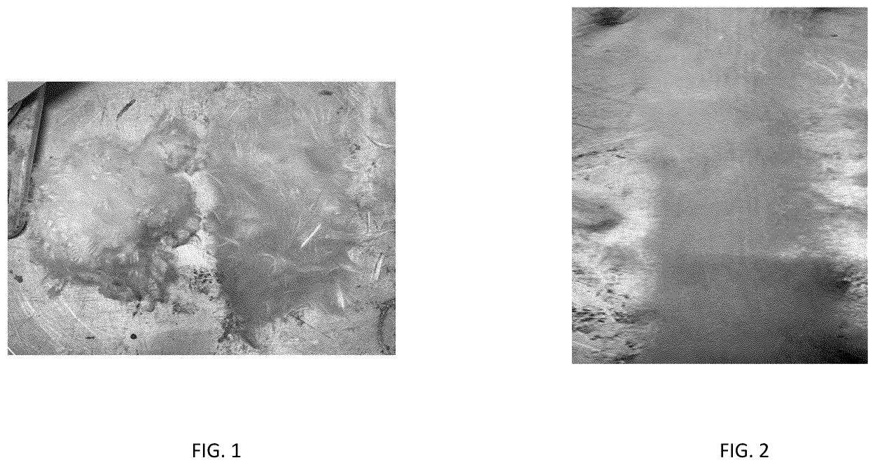

More particularly, fiber mats were produced by taking 15 g of recycled fiberglass and 15 g of crimped acrylic fiber (see FIG. 1) and feeding both materials into a carding machine. See FIG. 3. This machine produces a unidirectional mat (see FIG. 2) while mixing the two fiber types. The produced mat was then spun of a traditional spinning wheel to create a continuous yarn of the comingled fibers. See FIGS. 4 and 5. Once the material was spun into a yarn, the exterior of the yarn was melted using quick passes from a hair straightener set to a heat setting of 450° F. (232.2° C.).

### Rocket Winding and Production:

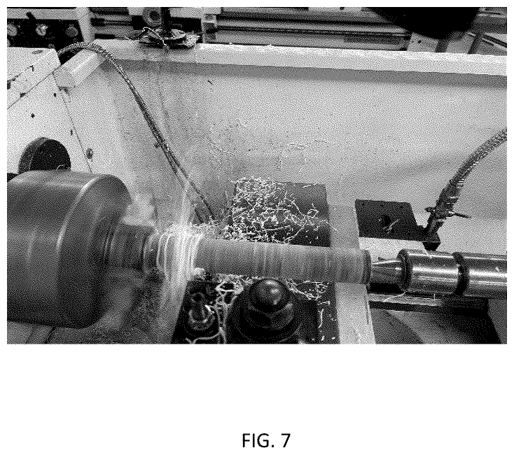

The yarns were run through an epoxy bath then wound on mandrels to form the rocket body and nosecone. See FIG. 6. The rocket body and nosecone used one layer of filament to achieve the necessary thickness of approximately 3 mm. Once wound, the epoxy was allowed to cure in place by maintaining the rotation of the mandrel. After the epoxy had set, the rocket body and nosecone were taken to a lathe and trimmed to produce a consistent exterior finish. See FIG. 7.

### Final Rocket Assembly:

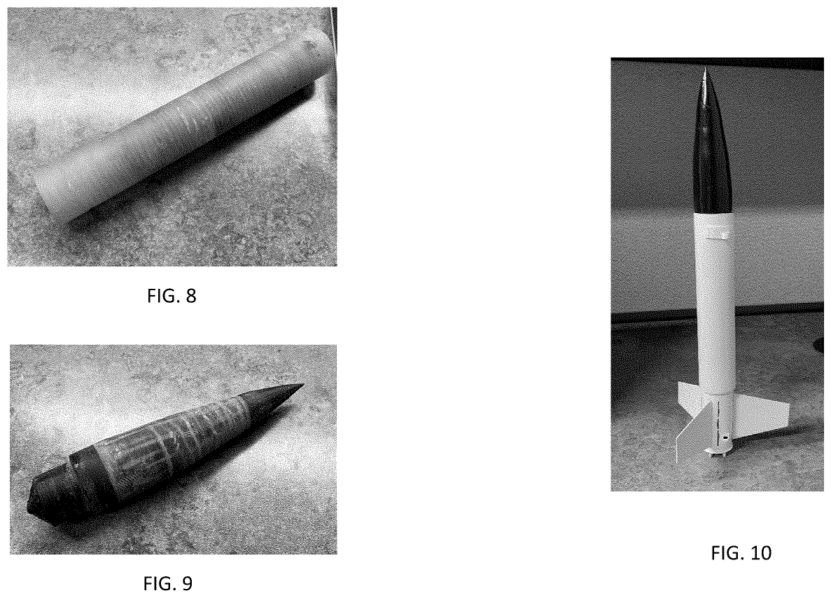

After trimming the rocket body and nosecone (see FIGS. 8 and 9), fins were added to the rocket. Once complete the rocket was sprayed with paint. See FIG. 10. The rocket motor, parachute, and other interior parts were added to the rocket using adhesives where necessary.

The presently disclosed subject matter can be embodied in other forms without departure from the spirit and essential characteristics thereof. The embodiments described therefore are to be considered in all respects as illustrative and not restrictive. Although the presently disclosed subject matter has been described in terms of certain preferred embodiments, other embodiments that are apparent to those of ordinary skill in the art are also within the scope of the present subject matter.

What is claimed is:

1. A method for preparing a fiber-reinforced composite component, the method comprising:
(a) forming one or more nonwoven mat comprising comingled glass fiber and thermoplastic fiber;
(b) spinning the nonwoven mat into a yarn; and
(c) embedding the yarn or a product thereof in a polymeric matrix, thereby preparing a fiber-reinforced composite component.

2. The method of claim 1, wherein the glass fiber comprises or consists of recycled glass fiber (RGF).

3. The method of claim 1, wherein the thermoplastic fiber comprises or consists of acrylic fiber.

4. The method of claim 1, wherein the thermoplastic fiber is a crimped fiber.

5. The method of claim 1, wherein the glass fiber and/or the thermoplastic fiber has a length of about 15 millimeters (mm) to about 125 mm.

6. The method of claim 1, wherein step (a) comprises carding the glass fiber and the polymeric fiber.

7. The method of claim 1, wherein the nonwoven mat comprises about 20% by weight to about 80% by weight acrylic fiber.

8. The method of claim 1, wherein the nonwoven mat comprises about 50% by weight glass fiber and about 50% by weight acrylic fiber.

9. The method of claim 1, wherein prior to step (c), the yarn is heat-treated.

10. The method of claim 1, wherein the thermoplastic fiber comprises acrylic fiber and the yarn is heat-treated prior to step (c) by exposing at least the exterior of the yarn to a temperature of about 230 degrees Celsius (° C.) to about 235° C.

11. The method of claim 1, wherein, prior to step (c), the yarn is processed to provide a textile, fabric or other product comprising the yarn.

12. The method of claim 1, wherein step (c) comprises impregnating the yarn or the product thereof with a thermosetting resin and curing the resin.

13. The method of claim 12, wherein step (c) comprises:
(c1) impregnating the yarn or the product thereof with the thermosetting resin to form an impregnated yarn or product thereof;
(c2) forming the impregnated yarn or product thereof into a predetermined shape; and
(c3) curing the resin.

14. The method of claim 1, wherein step (c) comprises impregnating the yarn or the product thereof with a thermoplastic resin and polymerizing the resin.

15. The method of claim 1, wherein step (c) comprises impregnating the yarn or the product thereof with a resin selected from the group consisting of an epoxy resin, a reactive liquid acrylic resin, an unsaturated polyester resin, a vinyl-ester resin, a polyamide resin and a polybutylene terephthalate resin.

16. The method of claim 1, wherein step (c) comprises pulling the yarn through a resin bath, vacuum resin infusion, or film infusion.

17. The method of claim 1, wherein step (c) comprises a technique selected from the group consisting of filament winding, tube rolling, automated fiber placement (AFP), infusion molding, compression molding, pultrusion, thermoforming, and resin-transfer molding.

18. A fiber-reinforced composite component prepared according to the method of claim 1.

19. A method of preparing a continuous yarn comprising glass and thermoplastic fibers, wherein the method comprises:
(a) forming one or more nonwoven mat comprising comingled glass fiber and thermoplastic fiber; and
(b) spinning the nonwoven mat into a continuous yarn.

20. A continuous yarn comprising comingled discontinuous glass fiber and thermoplastic fiber.

21. The continuous yarn of claim 20, wherein the discontinuous glass fiber is recycled glass fiber.

22. The continuous yarn of claim 20, wherein the yarn is impregnated with a thermosetting or thermoplastic resin.

23. A fabric or textile comprising the continuous yarn of claim 20.

24. An aligned non-crimp fabric comprising the continuous yarn of claim 20.

25. A fiber-reinforced composite comprising:
a thermoset or thermoplastic polymeric matrix; and
a continuous yarn of claim 20 embedded in the polymeric matrix.
